(19) United States
(12) Patent Application Publication
(10) Pub. No.: US 2023/0272498 A1
(43) Pub. Date: Aug. 31, 2023

(54) Cold rolled and annealed steel sheet and method of manufacturing the same

(71) Applicant: ArcelorMittal, Luxembourg (LU)

(72) Inventors: Astrid PERLADE, Le Ban-Saint-Martin (FR); Kangying ZHU, Metz (FR); Coralie JUNG, Metz (FR)

(21) Appl. No.: 18/016,403

(22) PCT Filed: Jul. 12, 2021
(86) PCT No.: PCT/IB2021/056235

§ 371 Date: Jan. 16, 2023

(30) Foreign Application Priority Data
Jul. 24, 2020 (WO) PCT/IB2020/056994

(51) Int. Cl. C21D 8/02; C21D 9/46; C22C 38/04; C22C 38/06; C22C 38/22; C22C 38/00

(52) U.S. Cl. CPC C21D 8/0236; C21D 8/0273; C21D 9/46; C22C 38/04; C22C 38/06; C22C 38/22; C22C 38/001; C22C 38/002; C21D 2211/001; C21D 2211/005; C21D 2211/008

(57) ABSTRACT

A cold rolled and annealed steel sheet, made of a steel having a composition including, by weight percent
C: 0.03-0.18%,
Mn: 6.0-11.0%,
Al: 0.2-3%,
Mo: 0.05-0.5%,
B: 0.0005-0.005%,
S≤0.010%,
P≤0.020%,
N≤0.008%,
   and including optionally one or more of the following elements, in weight percentage:
Si≤1.20%,
Ti≤0.050%,
Nb≤0.050%,
Cr≤0.5%,
V≤0.2%,
   the remainder of the composition being iron and unavoidable impurities resulting from the smelting,
   the steel sheet having a microstructure including, in surface fraction, from 25% to 54% of retained austenite, from 46% to 75% of ferrite, less than 8% of fresh martensite, a carbon [C]_{A} and manganese [Mn]_{A} content in austenite, expressed in weight percent, wherein [C]_{A}*√[Mn]_{A} is from 0.48 to 1.8, and an inhomogeneous repartition of manganese characterized by a manganese distribution with a slope above or equal to −50.

The present invention relates to a high strength steel sheet having good weldability properties and to a method to obtain such steel sheet.

### BACKGROUND

To manufacture various items such as parts of body structural members and body panels for automotive vehicles, it is known to use sheets made of DP (Dual Phase) steels or TRIP (Transformation Induced Plasticity) steels.

### SUMMARY OF THE INVENTION

One of the major challenges in the automotive industry is to decrease the weight of vehicles in order to improve their fuel efficiency in view of the global environmental conservation, without neglecting the safety requirements. To meet these requirements, new high strength steels are continuously developed by the steelmaking industry, to have sheets with improved yield and tensile strengths, and good ductility and formability.

One of the developments made to improve mechanical properties is to increase content of manganese in steels. The presence of manganese helps to increase ductility of steels thanks to the stabilization of austenite. But these steels present weaknesses of brittleness. To overcome this problem, elements as boron are added. These boron-added chemistries are very tough at the hot-rolled stage but the hot band is too hard to be further processed. The most efficient way to soften the hot band is batch annealing, but it leads to a loss of toughness.

In addition to these mechanical requirements, such steel sheets have to show a good resistance to liquid metal embrittlement (LME). Zinc or Zinc-alloy coated steel sheets are very effective for corrosion resistance and are thus widely used in the automotive industry. However, it has been experienced that arc or resistance welding of certain steels can cause the apparition of particular cracks due to a phenomenon called Liquid Metal Embrittlement (“LME”) or Liquid Metal Assisted Cracking (“LMAC”). This phenomenon is characterized by the penetration of liquid Zn along the grain boundaries of underlying steel substrate, under applied stresses or internal stresses resulting from restraint, thermal dilatation or phases transformations. It is known that adding elements like carbon or silicon are detrimental for LME resistance.

The automotive industry usually assesses such resistance by limiting the upper value of a so-called LME index calculated according to the following equation:

LME index=C %+Si %/4,

wherein C % and Si % stands respectively for the weight percentages of carbon and silicon in the steel.

The publication WO2020011638 relates to a method for providing a medium and intermediate manganese (Mn between 3.5 to 12%) cold-rolled steel with a reduced carbon content. Two process routes are described. The first one concerns an intercritical annealing of the cold rolled steel sheet. The second one concerns a double annealing of the cold rolled steel sheet, the first one being fully austenitic, the second one being intercritical. Thanks to the choice of the annealing temperature, a good compromise of tensile strength and elongation is obtained. By lowering annealing temperature an enrichment in austenite is obtained, which implies a good fracture thickness strain value. But the low amount of carbon and manganese used in the invention limits the tensile strength of the steel sheet to values not higher than 980 MPa.

An object of the present invention is to provide a cold rolled and annealed steel sheet having a combination of high mechanical properties with a tensile strength TS above or equal to 980 MPa, a uniform elongation UE above or equal to 15% and a total elongation TE above or equal to 20.0%.

Preferably, the cold rolled and annealed steel sheet has a total elongation TE and a hole expansion HE that satisfies TE×HE>670, where TE and HE are expressed in %.

Preferably, the cold rolled annealed steel sheet according to the invention has a yield strength YS above or equal to 800 MPa.

Preferably, the cold rolled annealed steel sheet according to the invention has a LME index of less than 0.36.

Preferably, the cold rolled and annealed steel sheet has a hole expansion ratio HE above or equal to 25.

Preferably, the cold rolled and annealed steel sheet according to the invention has a carbon equivalent Ceq lower than 0.4%, the carbon equivalent being defined as

Ceq=C %+Si %/55+Cr %/20+Mn %/19−Al %/18+2.2P %−3.24B %−0.133*Mn %*Mo %

with elements being expressed by weight percent.

Preferably, the resistance spot weld of two steel parts of the cold rolled and annealed steel sheet according to the invention has an α value of at least 30 daN/mm2.

Another purpose of the invention is to obtain a hot rolled and heat-treated steel sheet having high toughness with Charpy impact energy at 20° C. higher than 0.4 J/mm².

The present invention provides a cold rolled and annealed steel sheet, made of a steel having a composition comprising, by weight percent:
C: 0.03-0.18%
Mn: 6.0-11.0%
Al: 0.2-3%
Mo: 0.05-0.5%
B: 0.0005-0.005%
S≤0.010%
P≤0.020%
N≤0.008%
and comprising optionally one or more of the following elements, in weight percentage:
Si≤1.20%
Ti≤0.050%
Nb≤0.050%
Cr≤0.5%
V≤0.2%
the remainder of the composition being iron and unavoidable impurities resulting from the smelting, said steel sheet having a microstructure comprising, in surface fraction,
from 25% to 54% of retained austenite,
from 46% to 75% of ferrite,
less than 8% of fresh martensite,
a carbon [C]_{A} and manganese [Mn]_{A} content in austenite, expressed in weight percent, wherein [C]_{A}*√[Mn]_{A} is from 0.48 to 1.8,
and an inhomogeneous repartition of manganese characterized by a manganese distribution with a slope above or equal to −50.

### BRIEF DESCRIPTION OF THE DRAWINGS

FIG. 1 represents a section of the hot rolled and heat-treated steel sheet of trial 1 and trial 4.

FIG. 2 shows a plotted curve of accumulated area fraction with respect to Mn content for trial 1 and trial 4

### DETAILED DESCRIPTION

The invention will now be described in detail and illustrated by examples without introducing limitations.

According to the invention the carbon content is from 0.03% to 0.18% to ensure a satisfactory strength and good weldability properties. Above 0.18% of carbon, weldability of the steel sheet and the resistance to LME may be reduced. The temperature of the soaking depends on carbon content: the higher the carbon content, the lower the soaking temperature to stabilize austenite. If the carbon content is lower than 0.03%, the austenite fraction is not stabilized enough to obtain, after soaking, the desired tensile strength and elongation. In a preferred embodiment of the invention, the carbon content is from 0.05% to 0.15%. In another preferred embodiment of the invention, the carbon content is from 0.05% to 0.10%.

The manganese content is from 6.0% to 11.0%. Above 11.0% of addition, weldability of the steel sheet may be reduced, and the productivity of parts assembly can be reduced. Moreover, the risk of central segregation increases to the detriment of the mechanical properties. As the temperature of soaking depends on manganese content too, the minimum of manganese is defined to stabilize austenite, to obtain, after soaking, the targeted microstructure and strengths. Preferably, the manganese content is from 6.0% to 9%.

According to the invention, aluminium content is from 0.2% to 3% to decrease the manganese segregation during casting. Aluminium is a very effective element for deoxidizing the steel in the liquid phase during elaboration. Above 3% of addition, the weldability of the steel sheet may be reduced, so as castability. Moreover, tensile strength above 980 MPa is difficult to achieve. Moreover, the higher the aluminium content, the higher the soaking temperature to stabilize austenite. Aluminium is added at least 0.2% to improve product robustness by enlarging the intercritical range, and to improve weldability. Moreover, aluminium is added to avoid the occurrence of inclusions and oxidation problems. In a preferred embodiment of the invention, the aluminium content is from 0.7% to 2.2%.

The molybdenum content is from 0.05% to 0.5% to decrease the manganese segregation during casting. Moreover, an addition of at least 0.05% of molybdenum provides resistance to brittleness. Above 0.5%, the addition of molybdenum is costly and ineffective in view of the properties which are required. In a preferred embodiment of the invention, the molybdenum content is from 0.1% to 0.3%.

According to the invention, the boron content is from 0.0005% to 0.005% to improve the toughness of the hot rolled steel sheet and the spot weldability of the cold rolled steel sheet. Above 0.005%, the formation of boro-carbides at the prior austenite grain boundaries is promoted, making the steel more brittle. In a preferred embodiment of the invention, the boron content is from 0.001% to 0.003%.

Optionally some elements can be added to the composition of the steel according to the invention.

The maximum addition of silicon content is limited to 1.20% to improve LME resistance. In addition, this low silicon content makes it possible to simplify the process by eliminating the step of pickling the hot rolled steel sheet before the hot band annealing. Preferably the maximum silicon content added is 0.5%.

Titanium can be added up to 0.050% to provide precipitation strengthening. Preferably, a minimum of 0.010% of titanium is added in addition of boron to protect boron against the formation of BN.

Niobium can optionally be added up to 0.050% to refine the austenite grains during hot-rolling and to provide precipitation strengthening. Preferably, the minimum amount of niobium added is 0.010%.

Chromium and vanadium can optionally be respectively added up to 0.5% and 0.2% to provide improved strength.

The remainder of the composition of the steel is iron and impurities resulting from the smelting. In this respect, P, S and N at least are considered as residual elements which are unavoidable impurities. Their content is less than or equal to 0.010% for S, less than or equal to 0.020% for P and less than or equal to 0.008% for N.

The microstructure of the cold rolled and annealed steel sheet according to the invention will now be described. It contains, in surface fraction:
from 25% to 54% of retained austenite,
from 46% to 75% of ferrite,
less than 8% of fresh martensite,
a carbon [C]_{A} and manganese [Mn]_{A} content in austenite, expressed in weight percent, such that the product [C]_{A}*√[Mn]_{A} is from 0.48 to 1.8, and
an inhomogeneous repartition of manganese characterized by a manganese distribution with a slope above or equal to −50.

The microstructure of the steel sheet according to the invention contains from 25% to 54% of retained austenite and preferably from 30 to 50% of austenite. Below 25% or above 54% of austenite, the uniform and total elongation can not reach the minimum respective values of 15% and 20.0%.

Such austenite is formed during the intercritical annealing of the hot-rolled steel sheet but also during the first and second intercritical annealing of the cold rolled steel sheet. During the intercritical annealing of the hot rolled steel sheet, areas containing a manganese content higher than nominal value and areas containing manganese content lower than nominal value are formed, creating a heterogeneous distribution of manganese. Carbon co-segregates with manganese accordingly. This manganese heterogeneity is measured thanks to the slope of manganese distribution for the hot rolled steel sheet, which must be above or equal to −30, as shown in FIG. 2 and explained later.

Thanks to the inhomogeneous repartition of manganese in austenite after the hot band annealing and the low diffusion kinetics of manganese in austenite, the manganese heterogeneity formed during hot band annealing is still present after the first and second intercritical annealing of the cold rolled steel sheet. This can be evidenced by the slope of manganese distribution in the microstructure which is above or equal to −50.

The carbon [C]_{A} and manganese [Mn]_{A} contents in austenite, expressed in weight percent, are such that the product [C]_{A}*√[Mn]_{A} is from 0.48 to 1.8. When the ratio is below 0.48, the retained austenite is not stable enough to provide a continuous TRIP-TWIP effect during deformation. When it is above 1.8, the retained austenite is too stable to generate a sufficient TRIP-TWIP effect during deformation. Such TWIP-TRIP effect is notably explained in “Observation-of-the-TWIP-TRIP-Plasticity-Enhancement-Mechanism-in-Al-Added-6-Wt-Pct-Medium-Mn-Steel”, DOI: 10.1007/s11661-015-2854-z, The Minerals, Metals & Materials Society and ASM International 2015, p. 2356 Volume 46A, June 2015 (S. LEE, K. LEE, and B. C. DE COOMAN).

The microstructure of the steel sheet according to the invention contains from 46 to 75% of ferrite, preferably from 50 to 70% of ferrite. Such ferrite is formed during the second intercritical annealing of the cold rolled steel sheet.

Fresh martensite can be present up to 8% in surface fraction but is not a phase that is desired in the microstructure of the steel sheet according to the invention. It can be formed during the final cooling step to room temperature by transformation of unstable austenite. Indeed, this unstable austenite with low carbon and manganese contents leads to a martensite start temperature Ms above 20° C. To obtain the final mechanical properties, the fresh martensite is limited to a maximum of 8%, preferably to a maximum of 5%, or better to a maximum of 3% or even better reduced to 0.

The cold rolled and annealed steel sheet according to the invention has a tensile strength TS above or equal to 980 MPa, a uniform elongation UE above or equal to 15% a total elongation above or equal to 20.0%.

Preferably, the cold rolled and annealed steel sheet has a total elongation TE and a hole expansion HE that satisfies TE×HE>670.

Preferably, the cold rolled annealed steel sheet according to the invention has a yield strength YS above or equal to 800 MPa.

Preferably, the cold rolled annealed steel sheet according to the invention has a LME index of less than 0.36.

Preferably, the cold rolled and annealed steel sheet has a hole expansion ratio HE above or equal to 25.

Preferably, the cold rolled and annealed steel sheet according to the invention has a carbon equivalent Ceq lower than 0.4%, the carbon equivalent being defined as

Ceq=C %+Si %/55+Cr %/20+Mn %/19−Al %/18+2.2P %−3.24B %−0.133*Mn %*Mo %

with elements being expressed by weight percent.

A welded assembly can be manufactured by producing two parts out of sheets of cold rolled and annealed steel according to the invention, and then perform resistance spot welding of the two steel parts.

The resistance spot welds joining the first sheet to the second sheet are characterized by a high resistance in cross-tensile test defined by an α value of at least 30 daN/mm2.

The steel sheet according to the invention can be produced by any appropriate manufacturing method and the person skilled in the art can define one. It is however preferred to use the method according to the invention comprising the following steps:

A semi-product able to be further hot-rolled, is provided with the steel composition described above. The semi product is heated to a temperature from 1150° C. to 1300° C., so to make it possible to ease hot rolling, with a final hot rolling temperature FRT from 800° C. to 980° C. Preferably, the FRT is from 850° C. to 950° C.

The hot-rolled steel is then cooled and coiled at a temperature T_{coil} from 20° C. to 600° C., and preferably from 300 to 500° C.

The hot rolled steel sheet is then cooled to room temperature and can be pickled.

The hot rolled steel sheet is then annealed to an annealing temperature T_{HBA} between Ac1 and Ac3. More precisely, T_{HBA} is chosen to promote manganese inhomogeneous repartition. This manganese heterogeneity is measured thanks to the slope of manganese distribution for the hot rolled steel sheet, which must be above or equal to −30. Preferably the temperature T_{HBA} is comprised from Ac1+5° C. to Ac3. Preferably the temperature T_{HBA} is from 580° C. to 680° C.

The steel sheet is maintained at said temperature T_{HBA} for a holding time t_{HBA} from 0.1 to 120 h to promote manganese diffusion and formation of inhomogeneous manganese distribution. Moreover, this heat treatment of the hot rolled steel sheet allows decreasing the hardness while maintaining the toughness above 0.4 J/mm² of the hot-rolled steel sheet.

The hot rolled and heat-treated steel sheet is then cooled to room temperature and can be pickled to remove oxidation.

The hot rolled and heat-treated steel sheet is then cold rolled at a reduction rate from 20% to 80%.

The cold rolled steel sheet is then submitted to a first annealing at a soaking temperature T1ₛₒₐₖ from Ac3 to 950° C. for a holding time t1ₛₒₐₖ of 10 s to 1000 s. Ac3 is determined through dilatometry tests on the cold rolled steel sheet. Such first annealing allows keeping partially the manganese heterogeneity formed during hot band annealing. This is evidenced by the steel sheet showing a slope of manganese distribution in the microstructure of at least −60. In a preferred embodiment, this temperature is chosen to obtain an austenite grain size below 25 μm. Preferably, the annealing temperature T1ₛₒₐₖ is from 780 to 900° C. and more preferably from 780° C. to 870° C. and the time t1ₛₒₐₖ is from 100 to 500 s. Such first annealing can be performed by continuous annealing.

The cold rolled and annealed steel sheet is then cooled below 80° C. and preferably to room temperature.

Upon cooling, a large fraction of austenite which is less rich in manganese and carbon will transform into fresh martensite. This fresh martensite will contain areas enriched in manganese and carbon and areas depleted in manganese and carbon.

The cold rolled steel sheet is then submitted to a second annealing at an intercritical temperature T2ₛₒₐₖ going from Tc to 740° C. for a holding time t2ₛₒₐₖ of 10 s to 1800 s. Tc corresponds to the temperature at which carbides are fully dissolved and can be determined by FEG-SEM observations after heat treatment.

Preferably, the intercritical temperature T2ₛₒₐₖ is from 650° C. to 700° C. and t2ₛₒₐₖ is from to 100 to 500 s. Such second annealing can be performed by continuous annealing.

The value of the temperature of the second annealing is selected based on the composition of the grade, so that the austenite formed is stable enough and the formation of fresh martensite upon cooling is minimized. The higher the aluminium, the higher such temperature can be. The higher the manganese, the lower such temperature can be.

The cold rolled and double annealed steel sheet is then cooled below 80° C. and preferably to room temperature. Upon cooling, a fraction of austenite which is less rich in manganese and carbon may transform into a limited amount of fresh martensite.

The sheet can then be coated by any suitable process including hot-dip coating, electrodeposition or vacuum coating of zinc or zinc-based alloys or of aluminium or aluminium-based alloys.

The invention will be now illustrated by the following examples, which are by no way limitative.

### Examples

Five grades, whose compositions are gathered in table 1, were cast in semi-products and processed into steel sheets.

TABLE 1
Compositions

| | | | | | | | | | | | | | Ac1 | Ac3 |
|---|---|---|---|---|---|---|---|---|---|---|---|---|---|---|
| Steel | C | Mn | Al | Mo | B | S | P | N | Si | Nb | Ti | Ceq | (° C.) | (° C.) |
| A | 0.07 | 7.9 | 0.90 | 0.32 | 0.002 | 0.0015 | 0.011 | 0.003 | — | 0.032 | 0.015 | 0.15 | 560 | 830 |
| B | 0.09 | 9.5 | 1.69 | 0.33 | 0.0023 | 0.0015 | 0.01 | 0.003 | — | 0.031 | 0.015 | 0.15 | 550 | 845 |
| C | 0.15 | 7.7 | 0.96 | 0.22 | 0,0028 | 0.0022 | 0.012 | 0.003 | 0.02 | — | 0.018 | 0.33 | 560 | 820 |
| D | 0.19 | 7.6 | 1.00 | 0.22 | 0.0025 | 0.0022 | 0.01 | 0.003 | 0.8 | — | 0.024 | 0.38 | 560 | 820 |
| E | 0.20 | 4.8 | 0.02 | [symbol] | [symbol] | 0.001 | 0.02 | 0.004 | 1.5 | — | — | 0.52 | 610 | 765 |

Ac1 and Ac3 temperatures have been determined through dilatometry tests and metallography analysis.

The tested compositions are gathered in the following table wherein the element contents are expressed in weight percent.

| | |
|---|---|
| | Hot band annealing |
| Hot rolling | (HBA) |

| Trials | Steel | FRT (° C.) | T_{HBA}(° C.) | t_{HBA}(h) |
|---|---|---|---|---|
| 1 | A | 900 | 640 | 10 |
| 2 | A | 900 | 640 | 10 |
| 3 | A | 900 | 640 | 10 |
| 4 | A | 900 | — | — |
| 5 | A | 900 | — | — |
| 6 | B | 900 | 640 | 10 |
| 7 | B | 900 | 640 | 10 |
| 8 | B | 900 | 640 | 10 |
| 9 | B | 900 | 640 | 10 |
| 10 | B | 900 | 620 | 30 |
| 11 | B | 900 | 620 | 30 |
| 12 | C | 850 | 640 | 10 |
| 13 | C | 850 | 640 | 10 |
| 14 | C | 850 | 640 | 10 |
| 15 | C | 850 | 640 | 10 |
| 16 | C | 850 | 640 | 10 |
| 17 | C | 850 | 640 | 10 |
| 18 | C | 850 | 640 | 10 |
| 19 | C | 850 | 640 | 10 |
| 20 | C | 850 | 630 | 40 |
| 21 | D | 850 | 650 | 10 |
| 22 | E | 930 | 600 | 5 |

Underlined values: parameters which do not allow to obtain the targeted properties

Steel semi-products, as cast, were reheated at 1200° C., hot rolled and then coiled at 450° C. The hot rolled and coiled steel sheets are then heat treated at a temperature T_{HBA} and maintained at said temperature for a holding time t_{HBA}. The following specific conditions to obtain the hot rolled and heat-treated steel sheets were applied:

The hot rolled and heat-treated steel sheets were analyzed and the corresponding properties are gathered in table 3.

TABLE 3
Microstructure and properties of the hot
rolled and heat-treated steel sheet

| | Slope of the | Charpy energy |
|---|---|---|
| Trials | Mn distribution | (J/mm²) |
| 1 | −13 | 1.22 |
| 2 | −13 | 1.22 |
| 3 | −13 | 1.22 |
| 4 | −69 | 0.91 |
| 5 | −69 | 0.91 |
| 6 | −12 | 1.2 |
| 7 | −12 | 1.2 |
| 8 | −12 | 1.2 |
| 9 | −12 | 1.2 |
| 10 | −14 | 1.2 |
| 11 | −14 | 1.2 |
| 12 | −25 | 0.6 |
| 13 | −25 | 0.6 |
| 14 | −25 | 0.6 |
| 15 | −25 | 0.6 |
| 16 | −25 | 0.6 |
| 17 | −25 | 0.6 |
| 18 | −25 | 0.6 |
| 19 | −25 | 0.6 |
| 20 | −27 | 0.68 |
| 21 | Nd | 0.5 |
| 22 | Nd | 0.05 |

Underlined values: do not match the targeted values
Nd: not determined

The slope of the manganese distribution and the Charpy impact energy at 20° C., showing the toughness of the sheets, were determined.

The Charpy impact energy is measured according to Standard ISO 148-1:2006 (F) and ISO 148-1:2017(F).

The heat treatment of the hot rolled steel sheet allows manganese to diffuse in austenite: the repartition of manganese is heterogeneous with areas with low manganese content and areas with high manganese content. This manganese heterogeneity helps to achieve mechanical properties and can be measured thanks to manganese profile.

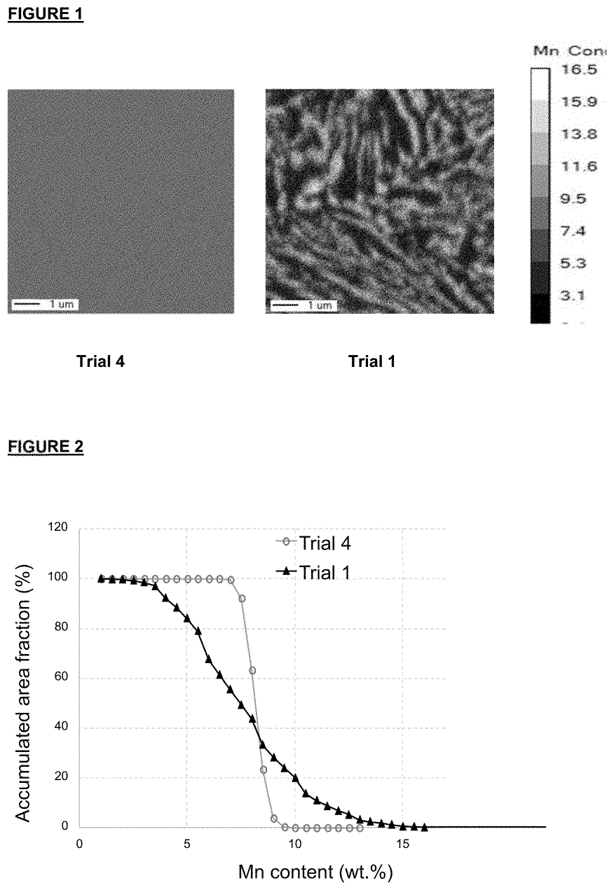

FIG. 1 represents a section of the hot rolled and heat-treated steel sheet of trial 1 and trial 4. The black area corresponds to area with lower amount of manganese, the grey area corresponds to a higher amount of manganese.

This figure is obtained through the following method: a specimen is cut at % thickness from the hot rolled and heat-treated steel sheet and polished.

The section is afterwards characterized through electron probe micro-analyzer, with a Field Emission Gun (“FEG”) at a magnification greater than 10000× to determine the manganese amounts. Three maps of 10 μm*10 μm of different parts of the section were acquired. These maps are composed of pixels of 0.01 μm². Manganese amount in weight percent is calculated in each pixel and is then plotted on a curve representing the accumulated area fraction of the three maps as a function of the manganese amount.

This curve is plotted in FIG. 2 for trial 1 and trial 4: 100% of the sheet section contains more than 1% of manganese. For trial 1, 20% of the sheet section contains more than 10% of manganese.

The slope of the curve obtained is then calculated between the point representing 80% of accumulated area fraction and the point representing 20% of accumulated area fraction.

For trial 1, this slope is higher than −30, showing that the repartition of manganese is heterogeneous, with areas with low manganese content and areas with high manganese content.

On the contrary, for trial 4, the absence of heat treatment after hot rolling implies that the repartition of manganese is not heterogeneous, which can be seen by the value of the slope of the manganese distribution lower than −30.

TABLE 4
Process parameters of the cold rolled and annealed steel sheets

| | Cold rolling | First annealing | | Second annealing | |
|---|---|---|---|---|---|
| Trials | (%) | T1ₛₒₐₖ(° C.) | T1ₛₒₐₖ(s) | T2ₛₒₐₖ(° C.) | T2ₛₒₐₖ(s) |
| 1 | 50 | 860 | 100 | 650 | 300 |
| 2 | 50 | 860 | 100 | 690 | 100 |
| 3 | 50 | 820 | 100 | 650 | 120 |
| 4 | — | — | — | 650 | 600 |
| 5 | — | 860 | 120 | 650 | 300 |
| 6 | 50 | 870 | 100 | 650 | 300 |
| 7 | 50 | 870 | 100 | 670 | 250 |
| 8 | 50 | 870 | 100 | 680 | 100 |
| 9 | 50 | 870 | 100 | 700 | 100 |
| 10 | 50 | 870 | 100 | 670 | 250 |
| 11 | 50 | 870 | 100 | 700 | 100 |
| 12 | 50 | 860 | 120 | 640 | 120 |
| 13 | 50 | 860 | 120 | 660 | 120 |
| 14 | 50 | 860 | 120 | 670 | 120 |
| 15 | 50 | 860 | 120 | 680 | 120 |
| 16 | 50 | 860 | 120 | 700 | 120 |
| 17 | 50 | 820 | 120 | 660 | 120 |
| 18 | 50 | 820 | 120 | 670 | 120 |
| 19 | 50 | 820 | 120 | 680 | 120 |
| 20 | 50 | 820 | 120 | 670 | 120 |

Underlined values: parameters which do not allow to obtain the targeted properties

The hot rolled and heat-treated steel sheet obtained are then cold rolled. The cold rolled steel sheet are then first annealed at a temperature T1ₛₒₐₖ and maintained at said temperature for a holding time t1ₛₒₐₖ, before being cooled below 80° C. The steel sheet is then annealed a second time at a temperature T2ₛₒₐₖ and maintained at said temperature for a holding time t2ₛₒₐₖ, before being cooled to room temperature. The following specific conditions to obtain the cold rolled and annealed steel sheets were applied:

Trials 2, 9, 11, 16 and 20 were submitted to a second annealing which temperature is too high.

Trial 4 was not submitted to a hot band annealing, nor to a cold rolling and was only submitted to the second annealing.

Trial 5 was not submitted to a hot band annealing, nor to a cold rolling.

Trial 12 was submitted to a second annealing at a temperature below Tc.

The cold rolled and annealed sheets were then analyzed, and the corresponding microstructure elements, mechanical properties and weldability properties were respectively gathered in table 5, 6 and 7.

TABLE 5
Microstructure of the cold rolled and annealed steel sheet

| | | | | | | | | Slope of the Mn | |
|---|---|---|---|---|---|---|---|---|---|
| | Retained | | Fresh | | | | Carbides | distribution | |
| | austenite | Ferrite | Martensite | [C]_{A}*√ | [C]_{A} | [Mn]_{A} | density | after first | after 2nd |
| Trials | (%) | (%) | (%) | [Mn]_{A} | (% wt) | (% wt) | (≤0.8 × 10⁶/mm²) | annealing | annealing |
| 1 | 30 | 70 | 0 | 0.57 | 0.18 | 9.9 | Yes | −28 | −24 |
| 2 | 32 | 57 | 11 | 0.41 | 0.13 | 9.8 | Yes | −28 | −23 |
| 3 | 35 | 65 | 0 | 0.51 | 0.16 | 10 | Yes | −21 | −20 |
| 4 | 30 | 70 | 0 | 0.43 | 0.15 | 8.4 | Yes | −69 | nd |
| 5 | 20 | 80 | 0 | 0.76 | 0.26 | 8.6 | Yes | −69 | nd |
| 6 | 45 | 55 | 0 | 0.58 | 0.18 | 10.5 | Yes | −26 | −23 |
| 7 | 46 | 54 | 0 | 0.55 | 0.17 | 10.5 | Yes | −26 | −22 |
| 8 | 53 | 46 | 1 | 0.49 | 0.15 | 10.5 | Yes | −26 | −22 |
| 9 | 55 | 43 | 2 | 0.46 | 0.14 | 10.6 | Yes | −26 | −21 |
| 10 | 52 | 48 | 0 | 0.49 | 0.15 | 10.5 | Yes | −27 | −22 |
| 11 | 55 | 45 | 0 | 0.46 | 0.14 | 10.6 | Yes | −27 | −22 |
| 12 | 22 | 78 | 0 | 1.86 | 0.61 | 9.3 | Yes | −34 | −29 |
| 13 | 30 | 70 | 0 | 1.36 | 0.45 | 9.2 | Yes | −34 | −27 |
| 14 | 35 | 65 | 0 | 1.17 | 0.39 | 9.0 | Yes | −34 | −26 |
| 15 | 40 | 60 | 0 | 1.01 | 0.34 | 8.9 | Yes | −34 | −25 |
| 16 | 50 | 40 | 10 | 0.70 | 0.24 | 8.4 | Yes | −34 | −23 |
| 17 | 38 | 62 | 0 | 1.08 | 0.36 | 9 | Yes | −30 | −25 |
| 18 | 40 | 60 | 0 | 1.04 | 0.35 | 8.9 | Yes | −30 | −24 |
| 19 | 43 | 57 | 0 | 0.95 | 0.32 | 8.8 | Yes | −30 | −23 |
| 20 | 40 | 45 | 15 | 0.76 | 0.26 | 8.5 | Yes | −31 | −27 |

Underlined values: not corresponding to the invention

The phase percentages of the microstructures of the obtained cold rolled and annealed steel sheet and the slopes of the manganese distribution after the first annealing and after the second one were determined.

[C]_{A} and [Mn]_{A} corresponds to the amount of carbon and manganese in austenite, in weight percent. They are measured with both X-rays diffraction (C %) and electron probe micro-analyzer, with a Field Emission Gun (Mn %).

The surface fractions of phases in the microstructure are determined through the following method: a specimen is cut from the cold rolled and annealed steel sheet, polished and etched with a reagent known per se, to reveal the microstructure. The section is afterwards examined through scanning electron microscope, for example with a Scanning Electron Microscope with a Field Emission Gun (“FEG-SEM”) at a magnification greater than 5000×, in secondary electron mode.

The determination of the surface fraction of ferrite is performed thanks to SEM observations after Nital or Picral/Nital reagent etching.

The determination of the volume fraction of retained austenite is performed thanks to X-ray diffraction.

The density of precipitated carbides is determined thanks to a section of sheet examined through Scanning Electron Microscope with a Field Emission Gun (“FEG-SEM”) and image analysis at a magnification greater than 15000×.

The heterogeneity of the manganese distribution obtained after the annealing of the hot rolled steel sheet is conserved after both annealing of the steel sheet. It can be seen by comparing slope of the manganese distribution obtained after annealing of the hot rolled steel sheet (in Table 3) and the slope of the manganese distribution obtained after both annealing of the cold rolled steel sheet (Table 5).

TABLE 6
Mechanical properties of the cold rolled and
annealed steel sheet

| | TS | UE | TE | YS | HE | TE × HE |
|---|---|---|---|---|---|---|
| Trials | (MPa) | (%) | (%) | (MPa) | (%) | (%²) |
| 1 | 1003 | 18 | 25.4 | 923 | 54 | 1359 |
| 2 | 1188 | 10 | 15.4 | 673 | 40 | 613 |
| 3 | 1017 | 20 | 23.6 | 948 | 51 | 1204 |
| 4 | 1055 | 8 | 12.5 | 990 | 49 | 615 |
| 5 | 986 | 8 | 14.9 | 905 | 45 | 671 |
| 6 | 1030 | 18 | 21.8 | 897 | 54 | 1186 |
| 7 | 1074 | 20 | 24.5 | 825 | 45 | 1103 |
| 8 | 1096 | 19 | 20.5 | 809 | 44 | 892 |
| 9 | 1205 | 17 | 19.4 | 699 | 29 | 561 |
| 10 | 1107 | 20 | 25.2 | 809 | 42 | 1061 |
| 11 | 1207 | 16 | 19.7 | 671 | 27 | 530 |
| 12 | 993 | 9 | 14.6 | 937 | Nd | Nd |
| 13 | 992 | 15 | 20.0 | 895 | 42 | 846 |
| 14 | 1037 | 18 | 21.8 | 853 | 31 | 685 |
| 15 | 1123 | 19 | 23.5 | 808 | 32 | 745 |
| 16 | 1513 | 14 | 15.5 | 644 | 18 | 274 |
| 17 | 1066 | 25 | 28.2 | 960 | 42 | 1184 |
| 18 | 1137 | 23 | 26.9 | 934 | 31 | 837 |
| 19 | 1260 | 20 | 25.1 | 823 | 27 | 680 |
| 20 | 1107 | 18 | 19.7 | 916 | 29 | 571 |

Underlined values: do not match the targeted values, nd: non determined value

Mechanical properties of the obtained cold rolled and annealed were determined and gathered in the following table.

The yield strength YS, the tensile strength TS and the total and uniform elongation TE, UE are measured according to ISO standard ISO 6892-1, published in October 2009. The test for Hole expansion ratio is conducted in accordance with ISO 16630 standards.

Trials 2, 9, and 11 show a [C]_{A}*√[Mn]_{A} below the minimum target, because

of a carbon concentration in austenite that is too low, due to the high temperature of the second annealing. Trials 9 and 11 show in addition a too high amount of austenite.

Moreover, trials 2, 16 and 20 include a high amount of fresh martensite because of the second annealing temperature which was too high.

Trial 12 shows a [C]_{A}*√[Mn]_{A} above the maximum target, due to the second annealing that was too low, leading to a high amount in carbon in the austenite.

Trial 4 shows a [C]_{A}*√[Mn]_{A} below the minimum target and manganese repartition that is homogeneous, because of the absence of hot band annealing.

Trial 5 shows a manganese repartition that is homogeneous and is also containing an austenite amount below the target, as it was not stabilized properly because of the absence of hot band annealing.

TABLE 7
Weldability properties of the cold rolled and annealed steel sheet

| | α | |
|---|---|---|
| Trials | (daN/mm²) | LME index |
| 1 | 60 | 0.07 |
| 2 | 60 | 0.07 |
| 3 | 60 | 0.07 |
| 4 | 60 | 0.07 |
| 5 | 60 | 0.07 |
| 6 | 63 | 0.09 |
| 7 | 63 | 0.09 |
| 8 | 63 | 0.09 |
| 9 | 63 | 0.09 |
| 10 | 63 | 0.09 |
| 11 | 63 | 0.09 |
| 12 | 40 | 0.16 |
| 13 | 40 | 0.16 |
| 14 | 40 | 0.16 |
| 15 | 40 | 0.16 |
| 16 | 40 | 0.16 |
| 17 | 40 | 0.16 |
| 18 | 40 | 0.16 |
| 19 | 40 | 0.16 |
| 20 | 40 | 0.16 |
| 21 | 28 | 0.39 |
| 22 | 24 | 0.58 |

LME index = C % + Si %/4, in wt %.

Spot welding in standard ISO 18278-2 condition was done on the cold rolled and annealed steel sheets.

In the test used, the samples are composed of two sheets of steel in the form of cross welded equivalent. A force is applied so as to break the weld point. This force, known as cross tensile Strength (CTS), is expressed in daN. It depends on the diameter of the weld point and the thickness of the metal, that is to say the thickness of the steel and the metallic coating. It makes it possible to calculate the coefficient α which is the ratio of the value of CTS on the product of the diameter of the welded point multiplied by the thickness of the substrate. This coefficient is expressed in daN/mm².

Weldability properties of the obtained cold rolled and annealed were determined and gathered in the following table:

What is claimed is:

1-12. (canceled)

13: A cold rolled and annealed steel sheet, made of a steel having a composition comprising, by weight percent:
C: 0.03-0.18%
Mn: 6.0-11.0%
Al: 0.2-3%
Mo: 0.05-0.5%
B: 0.0005-0.005%
S≤50.0100%
P≤0.020%
N≤0.008%
and optionally one or more of the following elements, in weight percentage:
Si≤1.20%
Ti≤0.050%
Nb≤0.050%
Cr≤0.50%
V≤0.2%
a remainder of the composition being iron and unavoidable impurities resulting from processing
the steel sheet having a microstructure comprising, in surface fraction, from 25% to 54% of retained austenite, from 46% to 75% of ferrite, less than 8% of fresh martensite, a carbon [C]_{A} and manganese [Mn]_{A} content in austenite, expressed in weight percent, wherein [C]_{A}*√[Mn]_{A} is from 0.48 to 1.8, and an inhomogeneous repartition of manganese defined by a manganese distribution with a slope above or equal to −50.

14: The cold rolled and annealed steel sheet as recited in claim 13 wherein the carbon content is from 0.05% to 0.15%.

15: The cold rolled and annealed steel sheet as recited in claim 13 wherein the manganese content is from 6.5% to 9.0%.

16: The cold rolled and annealed steel sheet as recited in claim 13 wherein the aluminium content is from 0.7% to 2.2%.

17: The cold rolled and annealed steel sheet as recited in claim 13 wherein the microstructure comprises a density of carbides below or equal to 0.8×106/mm².

18: The cold rolled and annealed steel sheet as recited in claim 13 wherein the tensile strength is above or equal to 980 MPa, the uniform elongation UE is above or equal to 15% and the total elongation TE is above or equal to 20.0%.

19: The cold rolled and annealed steel sheet as recited in claim 13 wherein the yield strength is above or equal to 800 MPa.

20: The cold rolled and annealed steel sheet as recited in claim 13 wherein the LME index is below 0.36.

21: The cold rolled and annealed steel sheet as recited in claim 13 wherein the hole expansion ratio HE is above or equal to 25%.

22: The cold rolled and annealed steel sheet as recited in claim 13 wherein the total elongation TE expressed in % and the hole expansion ratio HE expressed in %, satisfy following equation:
TE×HE>670

23: The cold rolled and annealed steel sheet as recited in claim 13 wherein the steel has a carbon equivalent Ceq lower than 0.4%, the carbon equivalent being defined as
Ceq=C %+Si %/55+Cr %/20+Mn %/19−Al %/18+2.2P %−3.24B %−0.133*Mn %*Mo %
with elements being expressed by weight percent.

24: A resistance spot weld of two steel parts of the cold rolled and annealed steel sheet as recited in claim 13, the resistance spot weld having an α value of at least 30 daN/mm2.
